(19) United States
(12) Patent Application Publication
(10) Pub. No.: US 2004/0024857 A1
(43) Pub. Date: Feb. 5, 2004

(54) Software methods of an optical networking apparatus with multiple multi-protocol optical networking modules having insertion and capture resources

(76) Inventor: Juliet Z. Cai, Beaverton, OR (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/210,989

(22) Filed: Aug. 2, 2002

(51) Int. Cl. G06F 15/16; G06F 15/173

(52) U.S. Cl. 709/223; 709/230

(57) ABSTRACT

An API is provided to an optical networking apparatus to facilitate uniform access, control or interaction with its multi-protocol optical networking modules (MPONM) by its applications. Each of the MPONM has a number of function blocks having corresponding drivers. In response to an application's request to initialize a MPONM, the module initialization function of the API cooperates with the function block drivers to create a data structure for the MPONM, and returns a handle of the data structure to the application. Thereafter, in response to a need to have an operation performed in a function block of a MPONM, such as a capture and/or insertion resource, the application makes the request with the API, including with the request an identification of the function block, and the handle of the data structure of the MPONM. Once a capture/insertion resource has been allocated, the API returns a handle corresponding to the allocated resource to the application for use in further requests.

### FIELD OF THE INVENTION

The present invention relates to software methods and networking apparatuses. More specifically, the present invention relates to software methods to provide uniform access, control and/or interaction with insertion and capture resources of multi-protocol network processors of multi-protocol optical networking modules (MPONM) in an optical networking apparatus.

### BACKGROUND OF THE INVENTION

With advances in integrated circuit, microprocessor, networking and communication technologies, an increasing number of devices, in particular, digital computing devices, are being networked together. Devices are often first coupled to a local area network, such as an Ethernet based office/home network. In turn, the local area networks are interconnected together through wide area networks, such as SONET networks, ATM networks, Frame Relays, and the like. Of particular importance is the TCP/IP based global inter-network, the Internet. Historically, data communication protocols specified the requirements of local/regional area networks, whereas telecommunication protocols specified the requirements of the regional/wide area networks. The rapid growth of the Internet has fueled a convergence of data communication (datacom) and telecommunication (telecom) protocols and requirements. It is increasingly important that data traffic be carried efficiently across local, regional, as well as wide area networks.

Because of this trend of increased connectivity, an increasing number of applications that are network dependent are being deployed. Examples of these network dependent applications include but are not limited to, the World Wide Web, email, Internet based telephony, and various types of e-commerce and enterprise applications. The success of many content/service providers as well as commerce sites depend on high-speed delivery of a large volume of data across wide areas. As a result, high-speed data trafficking devices, such as high-speed optical, or optical-electro routers, switches and so forth, are needed.

Unfortunately, because of the multiplicity of protocols, including datacom and telecom protocols, that may be employed to traffic data in the various types of networks, designers and developers of networking components and equipment, such as line cards, routers and switchers, have to wrestle with a multitude of prior art protocol processors. Each of these protocol processors is typically dedicated to the support of either local/regional or regional/wide area protocols, in their design of these components/equipment. This burden is costly, and slows down the advancement of high-speed networks.

U.S. patent application Ser. Nos. 09/860,207 and 09/861,002, both filed on May 18, 2001, entitled “A MULTI-PROTOCOL NETWORKING PROCESSOR WITH DATA TRAFFIC SUPPORT SPANNING LOCAL, REGIONAL AND WIDE AREA”, and “AN OPTICAL NETWORKING MODULE INCLUDING PROTOCOL PROCESSING AND UNIFIED SOFTWARE CONTROL” respectively, disclosed a novel highly flexible multi-protocol network processor capable of supporting high-speed data traffic in local, regional, and wide area networks, and a multi-protocol optical networking module that can be constructed from such a multi-protocol network processor. Resultantly, sophisticated optical-electrical networking apparatuses such as optical-electrical routers and switches may be built more efficiently with multiple ones of the disclosed multi-protocol optical networking module (each having its own multi-protocol network processor).

In turn, the task for developing networking applications for such sophisticated optical-electrical networking apparatus with multiple ones of the disclosed multi-protocol optical networking module (each having its own multi-protocol network processor) have become much more difficult. Accordingly, a software architecture, including methods, that reduces the complexity and improves the ease for developing networking applications for such complex networking apparatuses with multiple ones of the disclosed multi-protocol optical networking module (each having its own integrated multi-protocol network processor) is desired.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the software method of the present invention, including an optical-electrical networking apparatus having multiple MPONM (each integrated with a multi-protocol network processor and multiple insertion and capture resources), within which the present invention may be practiced, in accordance with one embodiment;

FIGS. 2a-2b illustrate the operational flow of aspects of a networking application of FIG. 1 interacting with the MPONM API of the present invention, to access, control and/or otherwise interact with the function blocks of the multi-protocol network processor of the MPONM, in accordance with one embodiment;

FIG. 3 illustrates the corresponding module data structures of a MPONM, employed to practice the present invention, in further detail, in accordance with one embodiment;

FIG. 4 illustrates the operational flow of aspects of a module initialization function of the MPONM API of the present invention, in accordance with one embodiment;

FIG. 5 illustrates a conventional composite STS-192 frame;

FIG. 6 illustrates one embodiment of a SONET function block having an array of programmable insertion units (PIUs) and programmable capture units (PCUs);

FIG. 7 illustrates an exemplary data organization suitable for use in configuring and managing the operation of each PIU and PCU of FIG. 6, in accordance with one embodiment of the invention;

FIG. 8 is an operation flow diagram illustrating operation of the MPONM API in initializing an insertion resource, in accordance with one embodiment of the invention

FIG. 9 illustrates one embodiment of an MPONM API operational flow of an insertion function to cause an initialized insertion resource to insert data;

FIG. 10 illustrates one embodiment of an MPONM API operational flow for initializing a capture resource; and

FIG. 11 illustrates one embodiment of an MPONM API operational flow for managing an event channel.

### DETAILED DESCRIPTION

The present invention includes software methods, in particular, an application programming interface (API) for networking applications to interact with insertion and capture resources of multi-protocol network processors of MPONM of an optical-electrical networking apparatus.

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will be apparent to one skilled in the art that the present invention may be practiced without the specific details. In other instances, well-known features are omitted or simplified in order not to obscure the present invention.

Terminology

Parts of the description will be presented in data processing terms, such as data, variables, methods, request, return, and so forth, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through electrical and/or optical components of a processor and its subsystems.

Part of the descriptions will be described using networking terms, including but not limited to:

| | |
|---|---|
| Egress | Outgoing data path from the system to the network |
| HDLC | High-Level Data Link Control. A communication |
| | protocol used in Packet over SONET switching |
| | network. |
| Ingress | Incoming data path from the network to the system |
| IP | Internet Protocol |
| LAN | Local Area Network |
| MAC | Media Access Control layer, defined for Ethernet |
| | systems |
| POS | Packet over SONET |
| PPP | Point to Point Protocol |
| SONET | Synchronous Optical network, a PHY |
| | telecommunication protocol |
| WAN | Wide Area Network |

The terms “provide” and “providing”, and other terms of the like, as used in this specification and in the claims, include indirect as well as direct provision of the object of the provision operation. That is, an entity A may “provide” another entity B with an item C (the object of the provision operation) directly, or indirectly by providing entity B with information to obtain the object item C, such as a pointer to a location from which the object item C may be obtained.

Section Headings, Order of Descriptions and Embodiments

Section headings are merely employed to improve readability, and they are not to be construed to restrict or narrow the present invention.

Various operations will be described as multiple discrete steps in turn, in a manner most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may.

Overview

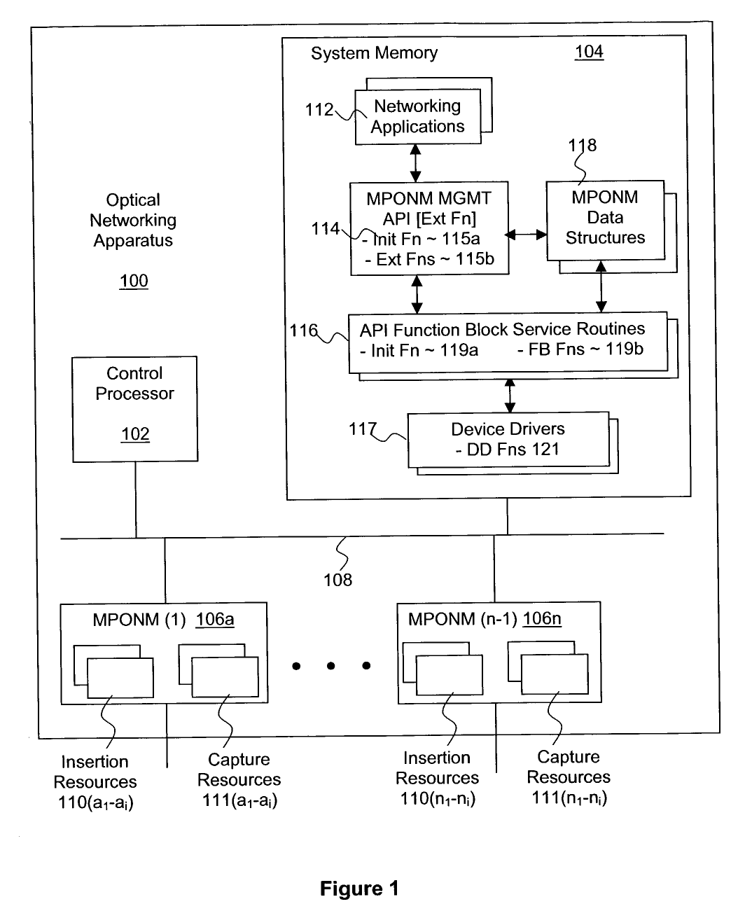

Referring now to FIG. 1, wherein a block diagram illustrating one embodiment of an optical-electrical networking apparatus having multiple MPONM within which the present invention may be practiced, is shown. As illustrated, for the embodiment, optical networking apparatus 100 includes a number of MPONM 106a-106n, a control processor 102, and memory 104, coupled to each other through system bus 108.

In various embodiments, the various MPONM 106a-106n may be connected to system bus 108 in like or different manners. For example, all MPONM 106a-106n may be connected via corresponding parallel interfaces, or some MPONM 106* may be connected via corresponding serial interfaces, while others are connected via corresponding parallel or other bus interfaces. Accordingly, for the embodiment, various device drivers 117 having functions 121 are provided to facilitate the various corresponding types of interfaces for connecting MPONM 106a-106n to system bus 108. That is, a serial interface oriented device driver 117 is provided to facilitate connection of some or all of MPONM 106a-106n via corresponding serial interfaces, a parallel interface oriented device driver 117 is provided to facilitate connection of some or all of MPONM 106a-106n via corresponding parallel interfaces, and so forth.

Each of MPONM 106a-106n includes at least one multi-protocol network processor having a number of function blocks, as e.g. described in further detail below as well as in the above-identified co-pending U.S. patent applications. The various function blocks are selectively employed in combination to service data transmission and receipt in accordance with a selected one of a number of frame based protocols, including frame based protocols encapsulated within a synchronous protocol, as well as streaming and packet variants of the synchronous protocol. These protocols include at least one each of a datacom and a telecom protocol.

In one embodiment, the function blocks include a system interface block, a network interface block, a control interface, a MAC block, an Ethernet 64/64 coder, an Ethernet on SONET coder block, a PPP protocol and HDLC processor block, a HDLC Packet over SONET coder block, a SONET path processor block, and a SONET section and line processor block. In one embodiment of the invention, each MPONM 106a-106n is further provided with a flexible multi-stage SONET overhead interface function block equipped with a plurality of insertion resources (110ₐ₁₋ₐᵢ₋110ₙ₁₋ₙᵢ) and capture resources (111ₐ₁₋ₐᵢ111ₙ₁₋ₙᵢ) to insert overhead values into SONET frames and to extract overhead values from SONET frames, respectively. In one embodiment, each MPONM 106a-106n is equipped with 40 programmable insertion resources and 40 programmable capture resources.

Thus, it should be appreciated that without the teachings of the present invention, if networking applications 112 are required to access, control or otherwise interact with multiple function blocks of multiple network processors on multiple MPONM directly, the complexity may become unmanageable if not prohibitive for the average software developer. This is especially true in view of the multiplicity of network processors and MPONM present in each optical networking apparatus 100, and the different manners the MPONM 106* may be connected, not to mention the multiplicity of programmable insertion and capture resources as well as other function-specific components provided by each MPONM.

Accordingly, under the present invention, MPONM API 114 and function block service routines 116 are provided for interfacing with the function blocks of the network processors of the MPONM, to insulate the complexity of the function blocks of the network processors of the MPONM from networking applications 112. In particular, for the embodiment, MPONM API 114 includes at least an externalized module initialization function 115a and a number of externalized functions 115b associated with corresponding function blocks, provided to further streamline the interactions between networking applications 112 and MPONM function block service routines 116. Examples of externalized functions 115b include but are not limited to externalized functions correspondingly associated with controlling the operations of the MAC, SONET, and other function blocks.

In various embodiments, a number of externalized cross function block functions (not shown) may also be provided as part of MPONM API 114. An example of such functions is a configuration function to set the various configurable parameters of the function blocks. The term “externalized” is used in the current context from the visibility perspective of networking applications 112 for ease of understanding. The characterization has no significance as to the essence of the present invention.

As will be described in more detail below, MPONM API 114 buffers networking applications 112 in accessing, controlling, or otherwise interacting with a MPONM through MPONM function block service routines 116 using MPONM data structures 118, one for each MPONM 106*. [The asterisk at the end of a reference number denotes a “wild card”, representing any of the trailing suffixes of the reference numbers employed in a figure. For example, 106* stands for 106a, 106b or any one of the other 106 references of FIG. 1.]

Except for MPONM API 114, including the initialization and externalized functions, the teachings of the present invention incorporated with function block service routines 116, and the manner in which networking applications 112 and function block service routines 116 cooperate with MPONM API 114, networking applications 112 and function block service routines 116 otherwise represent a broad range of such elements known in the art, and are typically application dependent. Accordingly, except for the manner networking applications 112 and function block service routines 116 cooperate with MPONM API 114, the two elements will not be otherwise further described.

Networking Applications

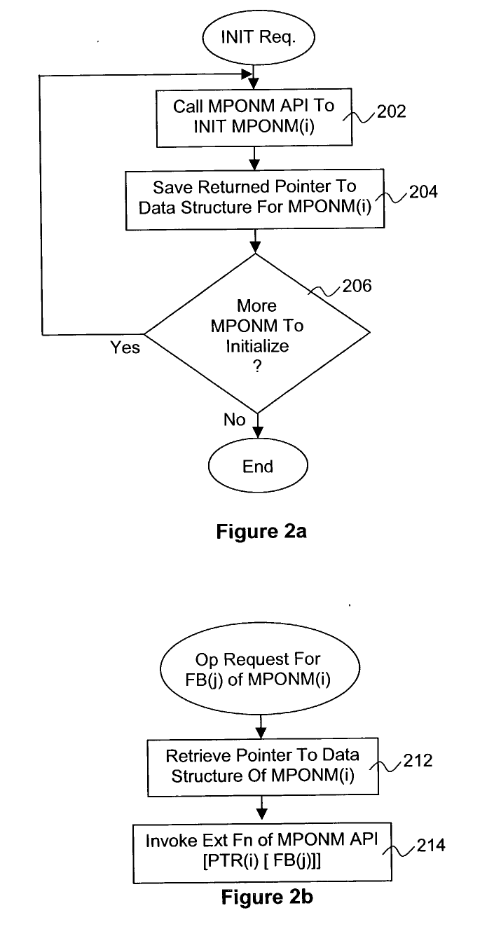

FIGS. 2a-2b illustrate aspects of an operating flow of networking applications 112 for practicing the present invention, in accordance with one embodiment. As illustrated in FIG. 2a, under the present invention i.e. with the provision of MPONM API 114 including an externalized module initialization function 115a, at initialization or a subsequent point in time at the desire of a networking application 112, the networking application 112 invokes the module initialization function 115a of MPONM API 114 to initialize a desired MPONM 106 for subsequent access, control or interaction by networking applications 112, block 202.

In one embodiment, networking application 112 identifies the particular MPONM 106* by providing the “handle” of the device driver 117 handling the connecting interface through which the particular MPONM 106* is connected to bus 108, and if applicable, information (such as memory mapped addresses, port numbers and so forth) associated with how the particular MPONM 106* is mapped on the connecting interface.

As will be described in more detail below, in response, the module initialization function 115a of MPONM API 114, in conjunction with the function block service routines 116 (more specifically, init function 119a of the function block service routines 116 ), advantageously creates an instance of a MPONM data structure 118 for the corresponding MPONM 106* to be initialized (if the module data structure 118 has not been previously created for the corresponding MPONM 106* ) to facilitate subsequent access, control and/or interaction with the corresponding MPONM 106* by networking applications 112. As part of the process, a handle of the module data structure 118 for the corresponding MPONM 106* is returned to the invoking one of networking applications 112. More specifically, in one embodiment, the “handle” is a pointer to the corresponding module data structure 118 of the initialized MPONM 106*.

Thus, as illustrated, networking application 112 saves the returned handle (or pointer) to the module data structure 118 for the MPONM 106 upon receipt of the handle (or pointer) from the module initialization function of MPONM API 114. Thereafter, networking application 112 determines if another MPONM 106 is to be initialized, block 206. If so, operations 202-204 are repeated; Otherwise the initialization process for networking application 112 proceeds to completion.

In other embodiments, a module initialization function 115a may support each initialization request requesting initialization of one or more desired MPONM 106* instead. For these embodiments, more than one desired MPONM 106* may be specified in a single request, with the request returning multiple corresponding handles (or pointers) for the successfully initialized ones of the requested MPONM 106*.

As illustrated in FIG. 2b, upon having a need to request a service or having an operation performed in a function block of a MPONM 106*, networking application 112 retrieves the handle (or pointer) to the module data structure 118 of the MPONM 106*, block 212, and then formats, and submits the request to an externalized function 115b of MPONM API 114, block 214. In the illustrated embodiment, some requests (e.g. requests associated with invoking cross function block externalized functions) may include identifications of the function blocks within which the requested operations are to be performed. However, whether through association of the invoked externalized function or identification, the identification of the function block is not particularized to a MPONM 106*; nor is an identification of the MPONM 106* provided. Instead, the MPONM 106* within which the identified function block the requested operation is to be performed is implicitly identified. More specifically, the handle (or pointer) of the corresponding module data structure 118 of the MPONM 106 is provided by networking application 112 in its request.

In one embodiment of the invention, an identification of the function block within which the requested operation is to be performed is provided to MPONM API 114 in conjunction with only the initial request for that function block. In response to an initial request directed to a given function block of a MPONM 106*, MPONM API 114 returns a handle that implicitly identifies the function block for simplified subsequent access by networking applications 112. In one embodiment, each subsequent request by networking applications 112 includes a first handle implicitly identifying a MPONM 106* that contains a function block to be accessed, and a second handle implicitly identifying the function block to be accessed and/or one or more resources associated therewith. For example, a request by networking applications 112 might include a first handle implicitly identifying a MPONM 106*, as well as a second handle implicitly identifying a SONET data insertion or capture resource located within a SONET function block of the MPONM 106* corresponding to the first handle. More specifically, the identification of the insertion/capture resource is not particularized to a MPONM 106*; nor is an identification of the MPONM 106* or insertion/capture resource provided. In one embodiment, the function block handle represents a pointer to a pointer of the module data structure 118 of the MPONM 106*, whereas in other embodiments the function block handle may represent a pointer to a separate module data structure 118 other than that of the MPONM 106*. In one embodiment, the handle implicitly identifying a SONET data insertion/capture resource is designed to communicate attributes of the resource to the MPONM API 114. More specifically, the insertion/capture resource handle is generated to reflect configuration information associated with the resource to facilitate control of e.g. the initialization, availability, settings, and access to the resource by MPONM API 114.

The implicit reference through the handle or pointer of the module data structure 118 of the MPONM 106* of interest, as well as the implicit reference by the secondary handle or pointer of the function block and/or resource within a function block to be accessed, improves the ease of use for the software developers of networking applications, who are more familiar with handles/pointers, as opposed to having to be cognizant of specific hardware modules and hardware details, including the details of the connection interfaces through which the MPONM 106* are correspondingly connected. This is especially true where the developers are required to reference multiple hardware modules each having a multiplicity of function blocks often times containing a multiplicity of shared resources including but not limited to programmable insertion and capture resources.

Thus, in accordance with one embodiment of the invention, one or more networking applications 112 can dynamically allocate, access, and release individual insertion and capture resources using one or more secondary handles implicitly identifying the associated resource, without the need for the developer to have specific knowledge of the hardware/software configuration or resource availability.

Module Data Structure

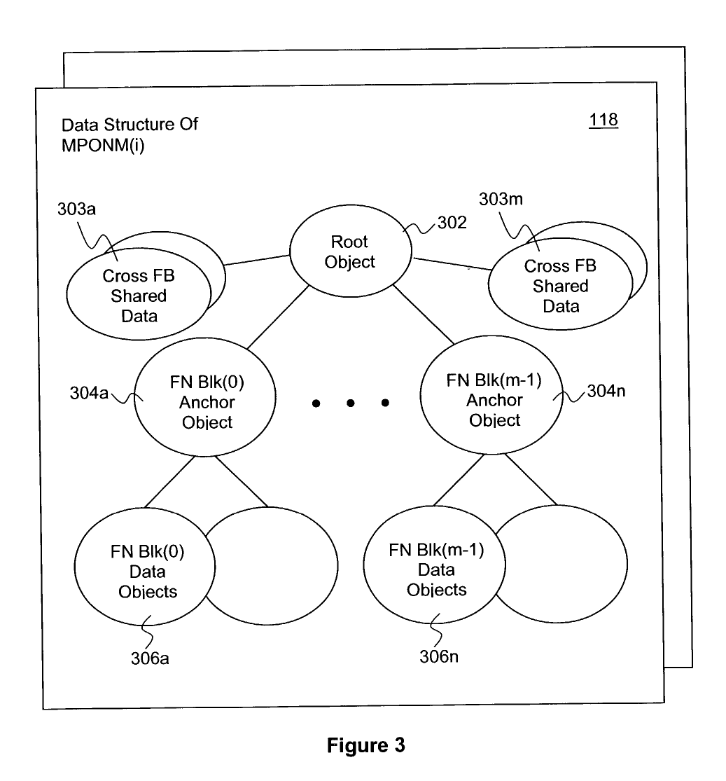

FIG. 3 illustrates an exemplary data organization suitable for use to store various module-related data to practice the present invention, in accordance with one embodiment. As illustrated, for the embodiment, module data structures 118 employed to facilitate the practice of the present invention are implemented in an object-oriented manner. As described earlier, one module data structure 118 is employed for each MPONM 106.

As illustrated, each module data structure 118 includes a root object 302 and cross function block objects 303* having cross function block shared data variables. Examples of data included in cross function block objects 303* include but are not limited to data and/or pointers employed in interacting with the appropriate device driver 117 for the particular MPONM 106*.

Additionally, each module data structure 118 includes a number of “anchor” data objects 304*, one each for the function blocks supported. “Anchor” data objects 304* may include a number of function block specific control data variables. Examples of such function block specific control data variables include status variables denoting e.g. whether the corresponding function block service routine 116 was successful in performing certain requested operations.

Further, attached with each “anchor” data objects 304* of the function blocks, are function block specific data objects 306a, having function block specific operational data variables. Examples of such function block specific operational data variables include bit masks, data rates, filter criteria, byte insertion/capture coordinates and values, overflow/underflow behavior, internal count, and so forth. In other embodiments, the present invention may be practiced using other data organizations.

Module Initialization Functions

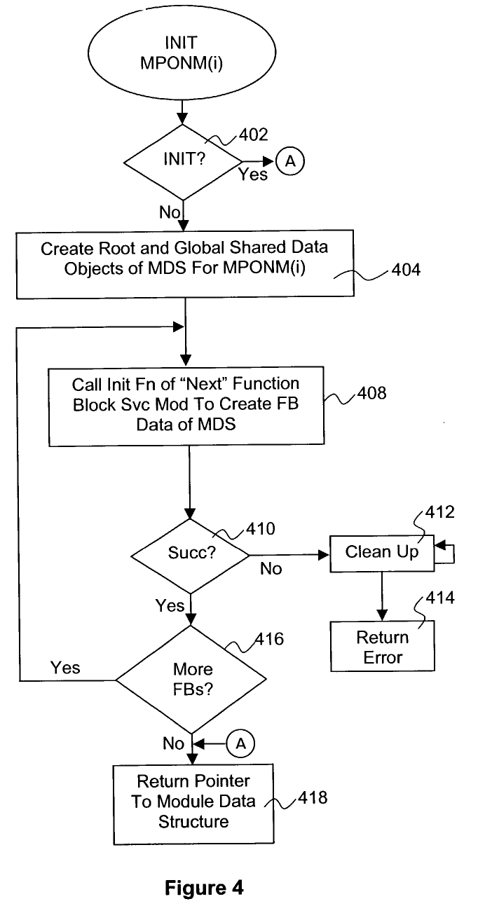

FIG. 4 illustrates the operating flow of aspects of the module initialization functions 115a of MPONM API 114 for practicing the present invention, in accordance with one embodiment.

As illustrated for the embodiment, upon receipt of a request to initialize a MPONM 106*, initialization function 115a of MPONM API 114 determines if the MPONM 106* has previously been initialized, block 402. More specifically, initialization function 115a determines whether the corresponding module data structure 118 of the MPONM 106* has previously been created or not (e.g. as a result of responding to another initialization request for the same MPONM 106 by the same or another networking application 112 ). If so, the module initialization function 115a returns the handler/pointer of the corresponding module data structure 118 of the MPONM 106, block 418.

Otherwise, i.e. if the module data structure 118 has not been previously created before, initialization function 115a creates the root and cross function block objects 302-303* of the module data structure 118 of the MPONM 106, block 404.

Thereafter, initialization function 115a successively calls the initialization functions 119a of the corresponding function block service routines 116 of the function blocks to contribute to the creation of data structure 118 to facilitate subsequent access, control or interaction with MPONM 106* by networking applications 112, block 408. In response, each of the initialization functions 119a of the corresponding function block service routines 116 creates the corresponding anchor and descendent data objects 304*-306* for the corresponding function block of the MPONM 106*, block 408.

For the embodiment, after each invocation, initialization function 115a further determines whether the contributory creation expected of the invoked initialization function 119a of the function block driver is successful, block 410. If an error is returned for the contributory creation, initialization function 115a successively undoes all prior successful additions to the module data structure 118, block 412, and initialization function 115a returns an error notice to the network application 112, block 414.

If the contributory creation was determined to be successful at block 410, the module initialization function further determines if more initialization functions 119a of additional function block service routines 116 are to be invoked, block 416. If at least one initialization function 119a of an additional function block service routine 116 is to be invoked, initialization function 115a continues operation at block 408 as earlier described. If not, the cooperative creation initialization process is completed, and initialization function 115a returns the handle/pointer of the module data structure 118 of MPONM 106* as earlier described, block 418.

In various embodiments, successive invocation of the initialization functions 119a of the function block service routines 116 to contribute to the creation of the module data structure 118 may be made in a predetermined order, to address certain application dependencies, such as data dependencies between data of different function blocks.

Invocation of Externalized Functions

Operationally, as described earlier, upon having a need to have an operation performed within a function block (of a MPONM 106* ), networking application 112 requests an appropriate externalized function 115b accordingly.

Typically, the same externalized function 115b is invoked for the same function block of different MPONM 106*. Moreover, the request does not explicitly identify the MPONM 106*, only the module data structure 118 of the MPONM 106*. Nevertheless, the invoked externalized function of the MPONM API 114 processes the request and interacts with the appropriate functions 119a of the appropriate function block service routines 116 to operate on the appropriate function block of the appropriate MPONM 106* accordingly. Resultantly, accessing, controlling or otherwise interacting with MPONM 106* by networking applications 112 is streamlined.

Note that as alluded to earlier, the exact manner an initialization function 119a of a function block service routine 116 contributes in the creation of the module data structure of a MPONM 106*, i.e. the kind of data variables the function block service routine 116 adds to, maintain, or otherwise manipulate, using module data structure 118 is application dependent. Similarly, the nature and the manner in which the various functions 119b of the function block service routine 116 interacts with the corresponding function blocks of MPONM 106*, are also application dependent. These issues vary from function blocks to function blocks.

SONET Processing and Termination Function Block

In accordance with one embodiment of the invention, a set of externalized software-based functions is provided to facilitate SONET/SDH processing and overhead termination within one or more MPONM 106*. The functions are used in conjunction with MPONM API 114 to access various hardware functionalities of one or more MPONM 106* without requiring any specific knowledge of the hardware configuration on the part of a developer of networking applications 112. Such functions can be used to access hardware functionality for a variety of purposes including, but not limited to SONET framing, scrambling/de-scrambling, parity (B1, B2 and B3 bytes), pointer processing, alarm signal processing, link monitoring of overhead, in addition to specifying insertion/capture of programmed overhead bytes of SONET frames.

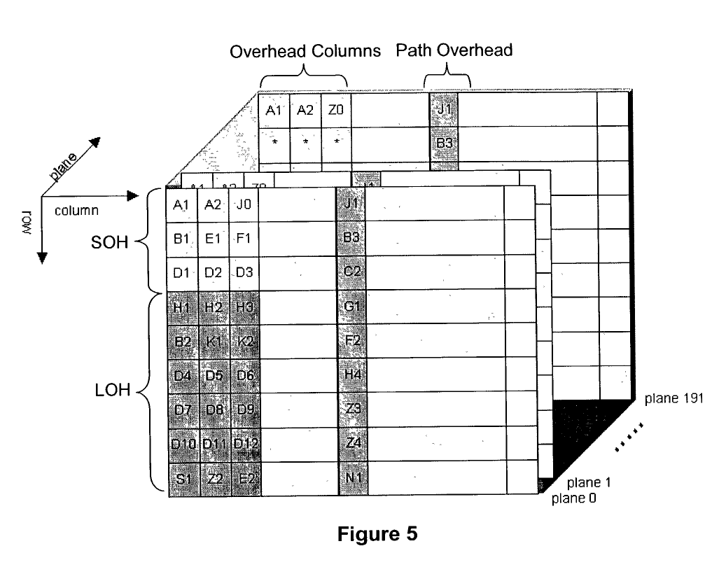

FIG. 5 illustrates a composite synchronous transport signal (STS-192) frame, which can be logically viewed as multiple 192 STS-1 frames stacked together as shown, where each plane represents an STS-1 frame. Accordingly, any byte within an STS-192 frame can be denoted by row, column, and plane coordinates. For example, the position of the J0 byte can be referenced by the coordinates (0,2,0) relative to the frame, assuming the indices are zero based, whereas the J1 byte can be referenced by the coordinates (0,0,0) relative to the payload (i.e. SPE). In one embodiment of the invention, MPONM API 114 facilitates the programmed insertion and capture of designated overhead bytes within a SONET frame using e.g. such coordinates as parameters to a function call by networking applications 112. In one embodiment, MPONM API 114 facilitates abstracted insertion/capture function calls by networking applications 112 where an MPONM 106* is designated using a first handle, and an insertion/capture resource associated with the MPONM 106* is designated using a second handle implicitly identifying the insertion/capture resource.

Accordingly, MPONM API 114 facilitates the dynamic initialization and un-initialization of programmable insert/capture resources such that the same insert/capture resource can be allocated for different purposes with different configurations at different times, transparently to networking applications 112. In one embodiment, in response to networking applications 112 having a need to request a service or have an operation performed by an insert/capture resource of an MPONM 106*, MPONM API 114 identifies an available insert/capture resource, initializes the resource, and returns a handle to the requesting networking application 112 upon successful initialization of the resource. In one embodiment, the handle is unique with respect to the MPONM containing the corresponding initialized resource, and is generated to include specific setting/configuration information of the particular resource for the benefit of MPONM API 114. In one embodiment, MPONM API 114 decodes the handle to ascertain the setting/configuration information upon receiving further requests by networking applications 112, thus facilitating a fast response by MPONM API 114 without the need to further query the hardware.

In accordance with one embodiment of the invention, MPONM API 114 facilitates independent configuration of one or more dedicated programmable insertion units (PIU) to write values to one or more indicated byte locations of a SONET frame. In one embodiment, once a PIU is programmed and activated, the PIU writes to the same location in all frames until deactivated by e.g. MPONM API 114. Similarly, in accordance with one embodiment of the invention, MPONM API 114 facilitates independent configuration of one or more dedicated programmable capture units (PCU) for capturing and processing of overhead byte values from any location within a SONET frame by networking applications 112. In one embodiment, each MPONM 106* contains 40 PIUs and 40 PCUs, however, any number of PIUs and PCUs may be used.

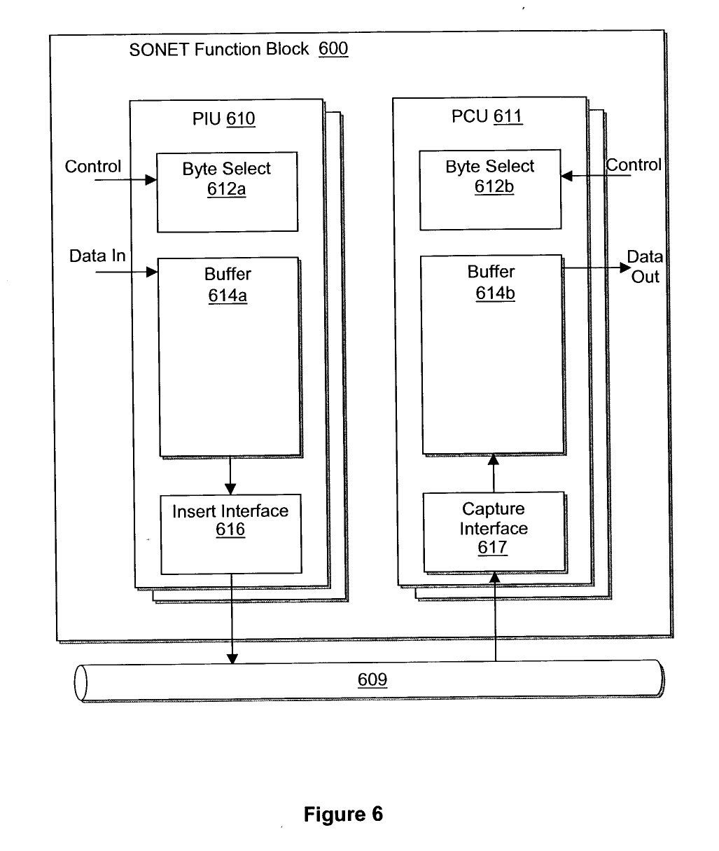

FIG. 6 illustrates one embodiment of a SONET function block 600 having an array of programmable insertion resources (PIU 610 ) and an array of programmable capture resources (PCU 611 ). Each PIU 610 includes a programmable byte select 612a, and a buffer 614a, while each PCU 611 includes a programmable byte select 612b, and a buffer 614b. Buffer 614a represents a reserved first-in-first-out (FIFO) buffer to store data to be inserted into a SONET frame, whereas buffer 614b represents a FIFO buffer to store data captured from a SONET frame. Buffers 614a and 614b may be implemented in a unified memory accessible by a host processor or direct memory access (DMA) controllers, or using individual FIFO memories. In one embodiment, each of buffers 614a and 614b stores 64 bytes of data. Byte select 612a and 612b can each be programmed e.g. by networking applications 112 via MPONM API 114 with row, column, and plane coordinates for the respective insert/capture resource to independently insert/capture data to/from a location corresponding to the coordinates in a SONET frame. Additionally, each PIU 610 includes insertion interface 616 to perform the data insertion, while each PCU 611 includes capture interface 617 to perform the data capture. The locations at which data is inserted by one or more PIUs 610 or extracted by one or more PCUs 611 can be measured with respect to the start of a frame, for data inserted in the section overhead (SOH) or line overhead (LOH) columns of a frame, or with respect to the boundary location of a synchronous payload envelope (SPE), for data inserted in the path overhead (POH) of a frame. In the case of POH insertion, an SPE boundary location can be identified by a pointer located in the LOH overhead.

Depending upon the depth of buffer 614a as compared to the rate at which buffer 614a is filled with insertion data (e.g. 8000 bytes/second for SONET), PIU 610 may experience data underflow. Upon data insertion during an underflow condition, a transmit buffer may repeat a last value, may wrap around to the oldest value, or stop transmitting entirely, based e.g. upon PIU configuration set by networking applications 112 via MPONM API 114. Similarly, depending upon the depth of buffer 614b as compared to the captured data fill rate (e.g. 8000 bytes/second), an overflow condition may occur. During A data overflow condition, buffer 614b drop new data, drop the oldest data, or simply overwrite the oldest values without changing the buffer location that is to be read, depending e.g. upon PCU configuration set by networking applications 112 via MPONM API 114.

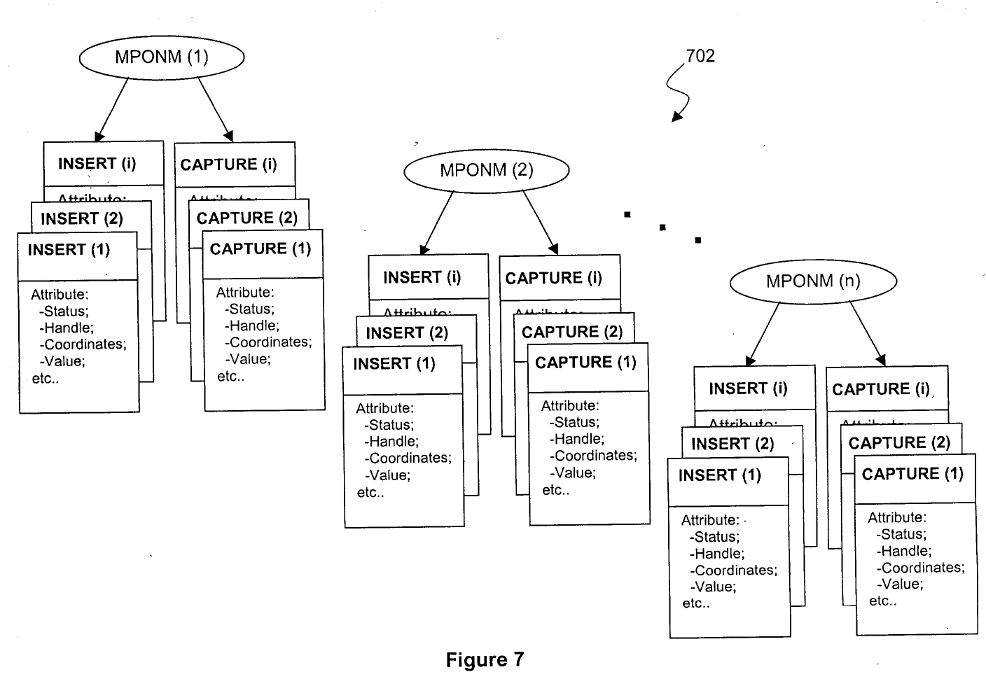

FIG. 7 illustrates an exemplary data organization ( 702 ) suitable for use in configuring and managing the operation of each PIU and PCU of the various MPONM 106*. In one embodiment, the data elements represented by data structure 702 correspond to one or more “anchor” data objects 304*, cross function block objects 303*, and/or function block specific data objects 306*. In one embodiment, data structure 702 identifies the status of each insertion/capture resource of each MPONM 106* within a given networking apparatus including whether a particular resource has been allocated or is available for allocation by a requesting networking application 112 via MPONM API 114. In one embodiment, each MPONM 106* is represented by a first handle assigned by MPONM API 114. Additionally, data structure 702 includes data elements representing various attributes/parameters associated with each insertion/capture resource of each MPONM 106*, including but not limited to handles assigned to each insertion/capture resource by MPONM API 114, coordinates (e.g. row, column, plane) indicating a position within a SONET frame to/from which the corresponding resource will insert/capture data, values to be inserted by an insertion resource, underflow/overflow behaviors, and so forth. For example, if a first networking application 112 attempts to insert a first value (e.g. 0×12) to a first location within a SONET frame (e.g. through initialization of a first insertion resource), and a second networking application 112 attempts to insert a second value into (e.g. 0×13) to the same location (e.g. through initialization of a second insertion resource), MPONM API 114 will not perform the second initialization based upon information stored within data structure 702 reflecting the resource conflict.

Insertion Resources

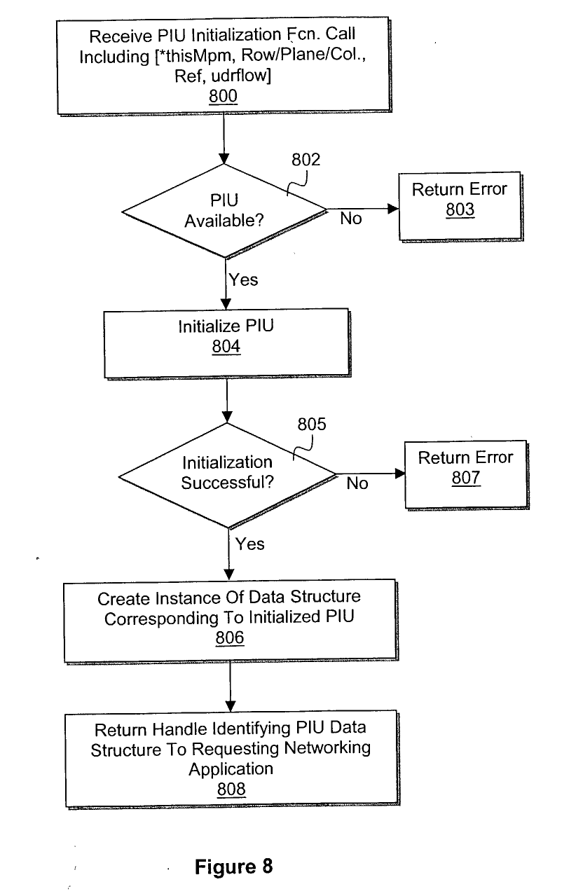

FIG. 8 illustrates one embodiment of an MPONM API operational flow for initializing an insertion resource. As illustrated, the process begins with the MPONM API receiving a function call including ‘*thisMpm’, ‘Row/Plane/Col.’, ‘Ref’ and ‘udrflow’ parameters (block 800). The ‘thisMpm’ parameter represents a pointer to a data structure representing a particular MPONM upon which the insertion resource to be initialized is located. The ‘Row/Plane/Col’ parameters represent coordinates indicating the location within the SONET frame to which data will be inserted, while the ‘Ref’ parameter specifies whether the insertion column is relative to the beginning of a frame or to the SPE. Lastly, the ‘udrflow’ parameter defines the underflow behavior for the insertion resource.

Once the MPONM API has identified the particular MPONM upon which an insertion resource to be initialized is located (e.g. based upon the Module handle), the MPONM API determines if an insertion resource is available for allocation (block 802 ). If an insertion resource is not available, an error is returned to requesting networking application 112 (block 803 ). However, if an insertion resource is available, the MPONM API identifies and attempts to initialize an insertion resource on that MPONM (block 804 ). If the initialization is not successful (e.g. due to another insertion resource being configured to insert to the same byte of a frame, a parameter being invalid, no insertion resource on that particular MPONM being available, and so forth) (block 805 ), an error/warning indicating that the initialization failed is returned to requesting networking applications 112 via the MPONM API (block 807 ). Alternatively, identification and initialization of another insertion resource may be attempted. However, if the initialization is successful (block 805 ), an instance of a data structure corresponding to the initialized insertion resource is created (block 806), and a handle implicitly identifying the initialized insertion resource is returned to requesting networking application 112.

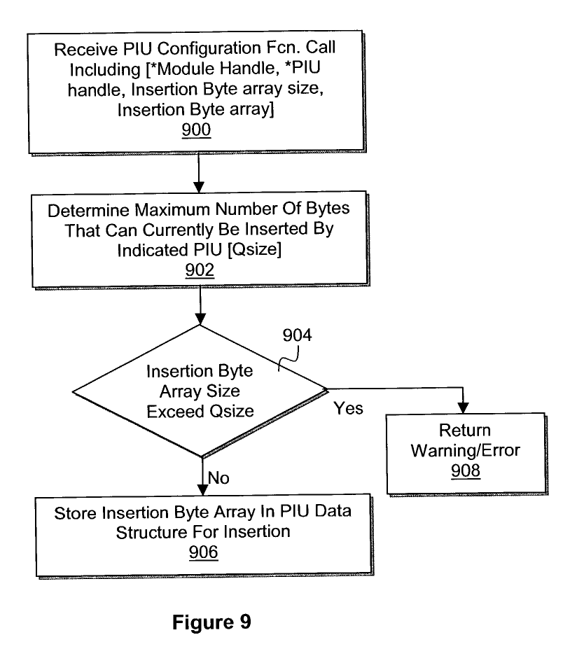

Once an insertion resource has been initialized, the insertion resource is ready to insert data (based upon e.g. the parameters provided by the requesting networking application 112 during initialization). Accordingly, FIG. 9 illustrates one embodiment of an MPONM API operational flow of an insertion function to cause an initialized insertion resource to insert data.

To begin, the MPONM API receives a function call having parameters including a handle implicitly identifying a module containing the insertion resource, a handle implicitly identifying the initialized insertion resource to perform the insertion, the size of the array of bytes to be inserted, and the actual array of bytes to be inserted (block 900). At block 902, the maximum number of bytes that can be inserted by the indicated insertion resource is determined. A determination is then made as to whether the insertion byte array size exceeds the maximum number of bytes that can be inserted by the indicated insertion resource (block 904). If the insertion byte array size exceeds the maximum number of bytes that can be inserted, an error/warning event is returned to requesting networking application 112 (block 908). However, if the insertion byte array size does not exceed the maximum number of bytes that can be inserted, the insertion byte array is stored in the data structure and/or FIFO for insertion into SONET frames (block 906).

Capture Resources

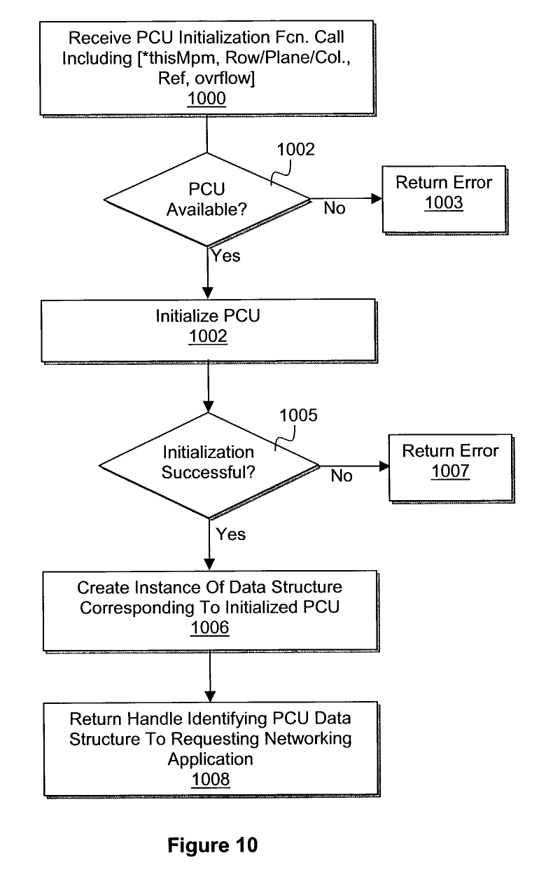

FIG. 10 illustrates one embodiment of an MPONM API operational flow for initializing a capture resource. As illustrated, the process begins with the MPONM API receiving a function call including parameters indicating a handle implicitly identifying a module containing a capture resource to be initialized, the coordinates indicating the location within the SONET frame from which data is to be captured, whether the insertion column is relative to the beginning of a frame or to the SPE, and the overflow behavior for the capture resource (*thisMpm, Row/Plane/Col., Ref and ovrflow parameters) (block 1000).

Once the MPONM API has identified a particular MPONM upon which a capture resource to be initialized is located (e.g. based upon the module handle), the MPONM API determines if a capture resource is available to be allocated (block 1002). If a capture resource is not available, an error is returned to requesting networking application 112 (block 1003). However, if a capture resource is available, the MPONM API identifies and attempts to initialize a capture resource on that MPONM (block 1004). If the initialization is not successful (e.g. due to a parameter being invalid, no capture resource on that particular MPONM being available, and so forth), (block 1005), an error/warning indicating that the initialization failed is returned to requesting networking applications 112 via the MPONM API (block 1007). Alternatively, identification and initialization of another capture resource may be attempted. However, if the initialization is successful (block 1005), an instance of a data structure corresponding to the initialized capture resource is created (block 1006), and a handle implicitly identifying the initialized capture resource is returned to requesting networking application 112.

In one embodiment of the invention, in order to retrieve captured values for a specified capture resource, networking applications 112 further utilize a ‘pcuGet’ function call of the MPONM API. The ‘pcuGet’ function takes parameters including the handle implicitly identifying a module, and the handle implicitly identifying an initialized insertion resource. Upon receiving such a function call, the MPONM API returns the array of bytes captured as well as the number of bytes returned in the captured byte array. In one embodiment, continuous data capture can be achieved by the MPONM API calling the ‘pcuGet’ function repeatedly such as within an interrupt subroutine. If, however, the function is not called frequently enough, a data overflow condition may result as the amount of data captured overflows the allotted buffer size.

Event Channels

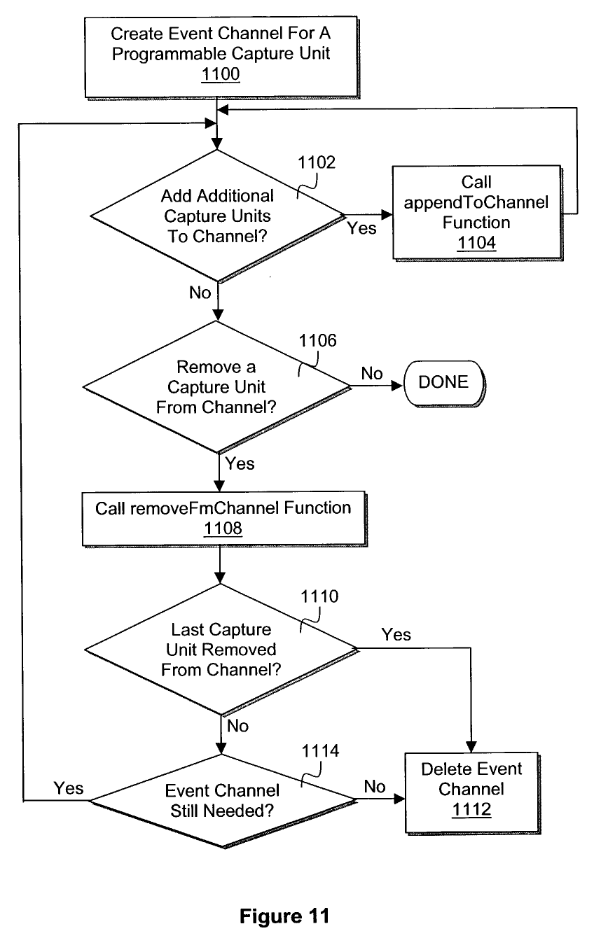

In one embodiment, each MPONM 106* provides seven independent interrupt/event channels that, in cooperation with MPONM API 114, can each be associated with one or more capture units to signal the change in a captured value from frame to frame of a SONET stream. FIG. 11 illustrates one embodiment of an MPONM API operational flow for managing an event channel. In accordance with one embodiment of the invention, MPONM API 114 facilitates the creation and deletion of event channels as well as the addition/removal of capture resources to/from an event channel.

Referring now to FIG. 11, an event channel is first created in association with a particular capture resource through e.g. a function call including a handle implicitly identifying a module containing the capture resource to be associated with the event channel, and a handle implicitly identifying a capture resource to be associated with the event channel (block 1100). If the function call is successful (i.e. the event channel is successfully created), a handle implicitly identifying the event channel is returned to requesting networking application 112. At block 1102, a determination is made as to whether additional capture resources are to be added to the newly established event channel. If additional capture resources are to be added to the newly established event channel, an appendToChannel function is called (block 1104). However, if additional capture resources are not to be added to the newly established event channel, a further determination is made as to whether a capture resource is to be removed from an event channel (block 1106). If a capture resource is not to be removed from an event channel, the process ends until networking application 112 requests another event-channel based function. If, however, a capture resource is to be removed from an event channel, a removeFmChannel function is called (block 1108). After the capture resource has been removed, a determination is made as to whether the last capture resource has been removed from the event channel (block 1110). If so, the event channel is deleted (e.g. via the delChannel function) (block 1112). If, however, the last capture resource has not been removed from the event channel, a further determination is made as to whether the event channel is still needed (block 1114). If so, the process repeats. If however, the event channel is no longer needed (block 1114), the event channel is deleted (block 1112). During the deletion process, all capture resources associated with the deleted event channel are disassociated, all the related register bits are cleared, interrupt handling is disabled, and the channel is marked as being available (e.g. for creation and association with one or more capture resources) once again. In one embodiment, both the appendToChannel and removeFmChannel functions take a module handle, a capture resource handle, and the event channel handle as parameters. In contrast, the delChannel function takes only the module handle and the event handle as parameters.

Note that although SONET processing and termination functions have been described above, the exact manner a function block service routine 116 contributes in the creation of the data structure of a MPONM 106*, i.e. the kind of data variables the function block service routine 116 adds to, maintains, or otherwise manipulates, using module data structure 118, is application dependent. Similarly, the nature and the manner the function block service routine 116 interacts with the MPONM 106* in particular the function block, are application dependent. These issues vary from function blocks to function blocks.

For ease of understanding, various functions have each been logically described as single functional entities. In practice however, the functions may be implemented in one or more sub-functions. Likewise, the functions may be combined into one or more broader functions.

Conclusion and Epilogue

Thus, it can be seen from the above descriptions, a novel highly flexible MPONM API equipped to streamline and improve the ease of network applications in accessing, controlling or otherwise interacting with function block of multi-protocol network processors of MPONM has been described. While the present invention has been described in terms of the above described embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. In an optical networking apparatus having a plurality of multi-protocol optical networking modules (MPONM), each having a plurality of programmable insertion resources and a plurality of programmable capture resources, a method of operation comprising:
a networking application, in response to a first need to have a first insertion operation performed in a first MPONM, requesting an externalized function of a MPONM application programming interface (API) to cause the first insertion operation to be performed by one of a plurality of programmable insertion resources of the first MPONM, including with the operation request a first handle of a first data structure implicitly identifying the first MPONM; and
the API determining a first programmable insertion resource to perform the first insertion operation, generating a second handle implicitly identifying the first programmable insertion resource, and returning the second handle to the requesting networking application.

2. The method of claim 1, wherein determining a first programmable insertion resource further comprises:
identifying the first programmable insertion resource as being available for allocation; and
initializing the first programmable insertion resource.

3. The method of claim 1, wherein the second handle is only returned to the requesting networking application after successful initialization of the first programmable insertion resource.

4. The method of claim 1, wherein the second handle is generated based at least in part upon configuration settings of the first programmable insertion resource.

5. The method of claim 1, further comprising:
the networking application further providing a SONET frame coordinate identifying a row position, a column position and a STS-1 level data plane to the API, said frame coordinate representing a location within each SONET frame to which the first programmable insertion resource will insert information.

6. The method of claim 5, wherein the first programmable insertion resource is uniquely programmed to insert data to the location corresponding to the frame coordinate.

7. The method of claim 5, further comprising:
the networking application further defining an underflow behavior type to the API, said underflow behavior type representing one of a plurality of actions to be taken by the first programmable insertion resource upon encountering an underflow condition.

8. The method of claim 7, wherein the plurality of actions comprises:
a first action in which the first programmable insertion resource repeatedly inserts at a point indicated by the SONET frame coordinate the last byte received by the first programmable insertion resource;
a second action in which the first programmable insertion resource repeatedly inserts an n-byte block of data); and
a third action in which no insertion is made.

9. The method of claim 1, wherein the method further comprises the networking application in response to a second need to have a first capture operation performed in the first MPONM, requesting an externalized function of the MPONM API to cause the first capture operation to be performed in the first MPONM, including with the first capture operation request, the first handle of the first data structure; and
the API determining a first programmable capture resource to perform the first capture operation, generating a third handle implicitly identifying the first programmable capture resource, and returning the third handle to the requesting networking application.

10. The method of claim 9, wherein the method further comprises the networking application in response to a third need to have a second insertion operation performed in the first MPONM, requesting an externalized function of the MPONM API to cause the second insertion operation to be performed in the first MPONM, including with the second insertion operation request, the first handle of the first data structure; and
the API determining a second programmable insertion resource to perform the second insertion operation, generating a fourth handle implicitly identifying the second programmable insertion resource, and returning the fourth handle to the requesting networking application.

11. The method of claim 9, wherein the method further comprises the networking application in response to a third need to have a second capture operation performed in the first MPONM, requesting an externalized function of the MPONM API to cause the second capture operation to be performed in the first MPONM, including with the second capture operation request, the first handle of the first data structure; and
the API determining a second programmable capture resource to perform the second capture operation, generating a fourth handle implicitly identifying the second programmable capture resource, and returning the fourth handle to the requesting networking application.

12. The method of claim 9, wherein the method further comprises the networking application in response to a third need to have a second insertion operation performed in a second MPONM, requesting an externalized function of the MPONM API to cause the second insertion operation to be performed in the second MPONM, including with the second insertion operation request, a first handle of a second data structure implicitly identifying the second MPONM; and
the API determining a second programmable insertion resource to perform the second insertion operation in the second MPONM, generating a fourth handle implicitly identifying the second programmable insertion resource in the second MPONM, and returning the fourth handle to the requesting networking application.

13. The method of claim 9, wherein the method further comprises the networking application in response to a third need to have a second capture operation performed in a second MPONM, requesting an externalized function of the MPONM API to cause the second capture operation to be performed in the second MPONM, including with the second capture operation request, a first handle of a second data structure implicitly identifying the second MPONM; and
the API determining a second programmable capture resource to perform the second capture operation in the second MPONM, generating a fourth handle implicitly identifying the second programmable capture resource in the second MPONM, and returning the fourth handle to the requesting networking application.

14. The method of claim 1, wherein the method further comprises the networking application in response to a second need to have a second insertion operation performed in the first MPONM, requesting an externalized function of the MPONM API to cause the second insertion operation to be performed in the first MPONM, including with the second insertion operation request, the first handle of the first data structure; and
the API determining a second programmable insertion resource to perform the second insertion operation, generating a third handle implicitly identifying the second programmable insertion resource, and returning the third handle to the requesting networking application.

15. The method of claim 14, wherein the method further comprises the networking application in response to a third need to have a third insertion operation performed in a second MPONM, requesting an externalized function of the MPONM API to cause the third insertion operation to be performed in the second MPONM, including with the third insertion operation request, a first handle of a second data structure implicitly identifying the second MPONM; and
the API determining a third programmable insertion resource to perform the third insertion operation in the second MPONM, generating a fourth handle implicitly identifying the third programmable insertion resource in the second MPONM, and returning the fourth handle to the requesting networking application.

16. The method of claim 14, wherein the method further comprises the networking application in response to a third need to have a first capture operation performed in a second MPONM, requesting an externalized function of the MPONM API to cause the first capture operation to be performed in the second MPONM, including with the first capture operation request, a first handle of a second data structure implicitly identifying the second MPONM; and
the API determining a first programmable capture resource to perform the first capture operation in the second MPONM, generating a fourth handle implicitly identifying the first programmable capture resource in the second MPONM, and returning the fourth handle to the requesting networking application.

17. The method of claim 1, wherein the method further comprises the networking application in response to a second need to have a second insertion operation performed in a second MPONM, requesting an externalized function of the MPONM API to cause the second insertion operation to be performed in the second MPONM, including with the second insertion operation request, a first handle of a second data structure implicitly identifying the second MPONM; and
the API determining a second programmable insertion resource to perform the second insertion operation in the second MPONM, generating a third handle implicitly identifying the second programmable insertion resource in the second MPONM, and returning the third handle to the requesting networking application.

18. The method of claim 1, wherein the method further comprises the networking application in response to a second need to have a first capture operation performed in a second MPONM, requesting an externalized function of the MPONM API to cause the first capture operation to be performed in the second MPONM, including with the first capture operation request, a first handle of a second data structure implicitly identifying the second MPONM; and the API determining a first programmable capture resource to perform the first capture operation in the second MPONM, generating a third handle implicitly identifying the first programmable capture resource in the second MPONM, and returning the third handle to the requesting networking application.

19. In an optical networking apparatus having a plurality of multi-protocol optical networking modules (MPONM), each having a plurality of programmable insertion resources and a plurality of programmable capture resources, a method of operation comprising:
a networking application, in response to a first need to have a first capture operation performed in a first MPONM, requesting an externalized function of a MPONM application programming interface (API) to cause the first capture operation to be performed by one of a plurality of programmable capture resources of the first MPONM, including with the operation request a first handle of a first data structure implicitly identifying the first MPONM; and
the API determining a first programmable capture resource to perform the first capture operation, generating a second handle implicitly identifying the first programmable capture resource, and returning the second handle to the requesting networking application.

20. The method of claim 19, wherein determining a first programmable capture resource further comprises:
identifying the first programmable capture resource as being available for allocation; and
initializing the first programmable capture resource.

21. The method of claim 19, wherein the second handle is only returned to the requesting networking application after successful initialization of the first programmable capture resource.

22. The method of claim 19, wherein the second handle is generated based at least in part upon configuration settings of the first programmable capture resource.

23. The method of claim 19, further comprising:
the networking application further providing a SONET frame coordinate identifying a row position, a column position and a STS-1 level data plane to the API, said frame coordinate representing a location within each SONET frame from which the first programmable capture resource will capture information.

24. The method of claim 23, wherein the first programmable capture resource is uniquely programmed to capture data from the location corresponding to the frame coordinate.

25. The method of claim 23, further comprising:
the networking application further defining an overflow behavior type to the API, said overflow behavior type representing one of a plurality of actions to be taken by the first programmable capture resource upon encountering an overflow condition including a loop on overflow action and a discard last action.

26. The method of claim 19, wherein the method further comprises the networking application, in response to a second need to have a second capture operation performed in the first MPONM, requesting an externalized function of the MPONM API to cause the second capture operation to be performed in the first MPONM, including with the second capture operation request, the first handle of the first data structure; and
the API determining a second programmable capture resource to perform the second capture operation, generating a third handle implicitly identifying the second programmable capture resource, and returning the third handle to the requesting networking application.

27. The method of claim 26, wherein the method further comprises the networking application in response to a third need to have a first insertion operation performed in a second MPONM, requesting an externalized function of the MPONM API to cause the first insertion operation to be performed in the second MPONM, including with the first insertion operation request, a first handle of a second data structure implicitly identifying the second MPONM; and
the API determining a first programmable insertion resource to perform the first insertion operation in the second MPONM, generating a fourth handle implicitly identifying the first programmable insertion resource in the second MPONM, and returning the fourth handle to the requesting networking application.

28. The method of claim 26, wherein the method further comprises the networking application in response to a third need to have a third capture operation performed in a second MPONM, requesting an externalized function of the MPONM API to cause the third capture operation to be performed in the second MPONM, including with the third capture operation request, a first handle of a second data structure implicitly identifying the second MPONM; and
the API determining a third programmable capture resource to perform the third capture operation in the second MPONM, generating a fourth handle implicitly identifying the third programmable capture resource in the second MPONM, and returning the fourth handle to the requesting networking application.

29. In an optical networking apparatus having a plurality of multi-protocol optical networking modules (MPONM), each having a plurality of programmable insertion resources and a plurality of programmable capture resources, a method of operation comprising:
a first networking application, in response to a first need to have a first insertion operation and a second need to have a first capture operation performed in a first MPONM, requesting one or more service functions of a MPONM application programming interface (API) to cause the first insertion operation to be performed by one of a plurality of programmable insertion resources of the first MPONM and the first capture operation to be performed by one of a plurality of programmable capture resources of the first MPONM, including with the operation request a first handle of a first data structure implicitly identifying the first MPONM;
the API determining a first insertion resource to perform the first insertion operation and a first capture resource to perform the first capture operation, generating a second handle implicitly identifying the first insertion resource and a third handle implicitly identifying the first capture resource, and returning the second and third handles to the requesting networking application.

30. The method of claim 29, wherein the method further comprises a second networking application, in response to a third need to have a second insertion operation performed in a first MPONM, requesting one or more service functions of a MPONM application programming interface (API) to cause the second insertion operation to be performed by one of a plurality of programmable insertion resources of the first MPONM, including with the operation request the first handle of first data structure;
the API determining a second insertion resource to perform the second insertion operation, generating a fourth handle implicitly identifying the second insertion resource, and returning the fourth handle to the requesting networking application.

31. The method of claim 30, wherein the method further comprises the second networking application, in response to a fourth need to have a second capture operation performed in a first MPONM, requesting one or more service functions of a MPONM application programming interface (API) to cause the second capture operation to be performed by one of a plurality of programmable capture resources of the first MPONM, including with the operation request the first handle of first data structure;
the API determining a second capture resource to perform the second capture operation, generating a second handle implicitly identifying the second insertion resource and a fifth handle implicitly identifying the second capture resource, and returning the fifth handle to the requesting networking application.

32. The method of claim 29, wherein the method further comprises a second networking application, in response to a third need to have a second insertion operation performed in a second MPONM, requesting one or more service functions of a MPONM application programming interface (API) to cause the second insertion operation to be performed by one of a plurality of programmable insertion resources of the second MPONM, including with the operation request a fourth handle of a second data structure implicitly identifying the second MPONM;
the API determining a first insertion resource of the second MPONM to perform the second insertion operation, generating a fifth handle implicitly identifying the second insertion resource, and returning the fifth handle to the requesting networking application.

33. The method of claim 32, wherein the method further comprises the second networking application, in response to a fourth need to have a second capture operation performed in a second MPONM, requesting one or more service functions of a MPONM application programming interface (API) to cause the second capture operation to be performed by one of a plurality of programmable capture resources of the second MPONM, including with the operation request the fourth handle of second data structure; the API determining a second capture resource to perform the second capture operation, generating a sixth handle implicitly identifying the second capture resource, and returning the sixth handle to the requesting networking application.

34. In an optical networking apparatus having a plurality of multi-protocol optical networking modules (MPONM), each having a plurality of programmable insertion resources and a plurality of programmable capture resources, a method of operation comprising:
receiving from a networking application, a first request to have a first insertion operation to be performed by one of a plurality of programmable insertion resources of a first MPONM, a first handle of a first data structure implicitly identifying the first MPONM included with the request;
determining a first programmable insertion resource to perform the first insertion operation;
generating a second handle implicitly identifying the first programmable insertion resource; and
returning the second handle to the requesting networking application.

35. The method of claim 34, wherein determining a first programmable insertion resource further comprises:
identifying the first programmable insertion resource as being available for allocation; and
initializing the first programmable insertion resource.

36. The method of claim 34, wherein the method further comprises receiving from the networking application, a request to have a first capture operation performed in the first MPONM, the first handle of the first data structure included with the first capture operation request;
determining a first programmable capture resource to perform the first capture operation;
generating a third handle implicitly identifying the first programmable capture resource; and
returning the third handle to the requesting networking application.

37. The method of claim 36, wherein the method further comprises receiving from the networking application, a request to have a second insertion operation performed in the first MPONM, the first handle of the first data structure included with the second insertion request;
determining a second programmable insertion resource to perform the second insertion operation;
generating a fourth handle implicitly identifying the second programmable insertion resource; and
returning the fourth handle to the requesting networking application.

38. The method of claim 36, wherein the method further comprises receiving from the networking application, a request to have a second capture operation performed in the first MPONM, the first handle of the first data structure included with the second capture operation request;
determining a second programmable capture resource to perform the second capture operation;
generating a fourth handle implicitly identifying the second programmable capture resource; and
returning the fourth handle to the requesting networking application.

39. The method of claim 36, wherein the method further comprises receiving from the networking application, a request to have a second insertion operation performed in a second MPONM, included with the second insertion operation request, a first handle of a second data structure implicitly identifying the second MPONM;
determining a second programmable insertion resource to perform the second insertion operation in the second MPONM;
generating a fourth handle implicitly identifying the second programmable insertion resource in the second MPONM; and
returning the fourth handle to the requesting networking application.

40. The method of claim 36, wherein the method further comprises receiving from the networking application, a request to have a second capture operation performed in a second MPONM, included with the second capture operation request, a first handle of a second data structure implicitly identifying the second MPONM;
determining a second programmable capture resource to perform the second capture operation in the second MPONM;
generating a fourth handle implicitly identifying the second programmable capture resource in the second MPONM; and
returning the fourth handle to the requesting networking application.

41. In an optical networking apparatus having a plurality of multi-protocol optical networking modules (MPONM), each having a plurality of programmable insertion resources and a plurality of programmable capture resources, a method of operation comprising:
receiving from a networking application, a request to have a first capture operation performed by a first capture resource of the first MPONM, including with the operation request a first handle of a first data structure implicitly identifying the first MPONM;
determining a first programmable capture resource to perform the first capture operation;
generating a second handle implicitly identifying the first programmable capture resource; and
returning the second handle to the requesting networking application.

42. The method of claim 41, wherein the method further comprises receiving from the networking application a request to have a second capture operation performed in the first MPONM, included with the second capture operation request, the first handle of the first data structure;
determining a second programmable capture resource to perform the second capture operation;
generating a third handle implicitly identifying the second programmable capture resource; and
returning the third handle to the requesting networking application.

43. The method of claim 42, wherein the method further comprises receiving from the networking application, a request to have a first insertion operation performed in a second MPONM, included with the first insertion operation request, a first handle of a second data structure implicitly identifying the second MPONM;
determining a first programmable insertion resource to perform the first insertion operation in the second MPONM;
generating a fourth handle implicitly identifying the first programmable insertion resource in the second MPONM; and
returning the fourth handle to the requesting networking application.

44. The method of claim 42, wherein the method further comprises receiving from the networking application, a request to have a third capture operation performed in a second MPONM, including with the third capture operation request, a first handle of a second data structure implicitly identifying the second MPONM;
determining a third programmable capture resource to perform the third capture operation in the second MPONM;
generating a fourth handle implicitly identifying the third programmable capture resource in the second MPONM; and
returning the fourth handle to the requesting networking application.

45. A networking apparatus comprising:
a plurality of multi-protocol optical networking modules (MPONM), each having a plurality of programmable insertion resources and a plurality of programmable capture resources;
memory coupled to the plurality of MPONM, having stored therein a plurality of programming instructions implementing one or more functions of an application programming interface (API) to
receive from a networking application, a first request to have a first insertion operation performed by one of a plurality of programmable insertion resources of a first MPONM, a first handle of a first data structure implicitly identifying the first MPONM included with the request,
determine a first programmable insertion resource to perform the first insertion operation,
generate a second handle implicitly identifying the first programmable insertion resource, and
return the second handle to the requesting networking application; and
at least one processor coupled to the memory and the plurality of MPONM to execute the programming instructions.

46. The networking apparatus of claim 45, wherein the plurality of programming instructions further comprise instructions to
identify the first programmable insertion resource as being available for allocation; and
initialize the first programmable insertion resource.

47. The networking apparatus of claim 45, wherein the plurality of programming instructions further comprises instructions to
receive from the networking application, a request to have a first capture operation performed in the first MPONM, the first handle of the first data structure included with the first capture operation request;
determine a first programmable capture resource to perform the first capture operation;
generate a third handle implicitly identifying the first programmable capture resource; and
return the third handle to the requesting networking application.

48. The networking apparatus of claim 46, wherein the plurality of programming instructions further comprises instructions to
receive from the networking application, a request to have a second insertion operation performed in the first MPONM, the first handle of the first data structure included with the second insertion request;
determine a second programmable insertion resource to perform the second insertion operation;
generate a fourth handle implicitly identifying the second programmable insertion resource; and
return the fourth handle to the requesting networking application.

49. The networking apparatus of claim 46, wherein the plurality of programming instructions further comprises instructions to
receive from the networking application, a request to have a second capture operation performed in the first MPONM, the first handle of the first data structure included with the second capture operation request;
determine a second programmable capture resource to perform the second capture operation;
generate a fourth handle implicitly identifying the second programmable capture resource; and
return the fourth handle to the requesting networking application.

50. The networking apparatus of claim 46, wherein the plurality of programming instructions further comprises instructions to
receive from the networking application, a request to have a second insertion operation performed in a second MPONM, included with the second insertion operation request, a first handle of a second data structure implicitly identifying the second MPONM;
determine a second programmable insertion resource to perform the second insertion operation in the second MPONM;
generate a fourth handle implicitly identifying the second programmable insertion resource in the second MPONM; and
return the fourth handle to the requesting networking application.

51. The networking apparatus of claim 46, wherein the plurality of programming instructions further comprises instructions to
receive from the networking application, a request to have a second capture operation performed in a second MPONM, included with the second capture operation request, a first handle of a second data structure implicitly identifying the second MPONM;
determine a second programmable capture resource to perform the second capture operation in the second MPONM;
generate a fourth handle implicitly identifying the second programmable capture resource in the second MPONM; and
return the fourth handle to the requesting networking application.

52. A networking apparatus comprising:
a plurality of multi-protocol optical networking modules (MPONM), each having a plurality of programmable insertion resources and a plurality of programmable capture resources;
memory coupled to the plurality of MPONM, having stored therein a plurality of programming instructions implementing one or more functions of an application programming interface (API) to
receive from a networking application, a request to have a first capture operation performed by a first capture resource of the first MPONM, including with the operation request a first handle of a first data structure implicitly identifying the first MPONM,
determine a first programmable capture resource to perform the first capture operation,
generate a second handle implicitly identifying the first programmable capture resource, and
return the second handle to the requesting networking application; and
at least one processor coupled to the memory and the plurality of MPONM to execute the programming instructions.

53. The networking apparatus of claim 52, wherein the plurality of programming instructions further comprises receiving from the networking application a request to have a second capture operation performed in the first MPONM, included with the second capture operation request, the first handle of the first data structure;
determining a second programmable capture resource to perform the second capture operation;
generating a third handle implicitly identifying the second programmable capture resource; and
returning the third handle to the requesting networking application.

54. The networking apparatus of claim 53, wherein the plurality of programming instructions further comprises instructions to
receive from the networking application, a request to have a first insertion operation performed in a second MPONM, included with the first insertion operation request, a first handle of a second data structure implicitly identifying the second MPONM;
determine a first programmable insertion resource to perform the first insertion operation in the second MPONM;
generate a fourth handle implicitly identifying the first programmable insertion resource in the second MPONM; and
return the fourth handle to the requesting networking application.

55. The networking apparatus of claim 53, wherein the plurality of programming instructions further comprises instructions to
receive from the networking application, a request to have a third capture operation performed in a second MPONM, including with the third capture operation request, a first handle of a second data structure implicitly identifying the second MPONM,
determine a third programmable capture resource to perform the third capture operation in the second MPONM;
generate a fourth handle implicitly identifying the third programmable capture resource in the second MPONM; and
return the fourth handle to the requesting networking application.
